(19) United States
(12) Patent Application Publication
(10) Pub. No.: US 2004/0139194 A1
(43) Pub. Date: Jul. 15, 2004

(54) System and method of measuring and monitoring network services availablility

(76) Inventor: Narayani Naganathan, Sunnyvale, CA (US)

Correspondence Address: HICKMAN PALERMO TRUONG & BECKER LLP, 1600 WILLOW STREET, SAN JOSE, CA, 95125-5106, US

(21) Appl. No.: 10/339,875

(22) Filed: Jan. 10, 2003

(51) Int. Cl. G06F 15/173

(52) U.S. Cl. 709/224

(57) ABSTRACT

In a computer network system, a service monitoring and measurement system is described having a plurality of service transaction modules to enable a user to remotely or locally monitor and/or measure the availability of network services. The service measurement and monitor includes logic to monitor and manage network services by allowing a user to request service availability by periodically sending service packets from the transaction modules to the service server. The service measurement and monitor system advantageously ensures status state change in a particular service one hierarchy level of the host device being monitored is retained and communicated to other hierarchy levels as the user measures service availability on the network.

### FIELD OF THE INVENTION

The present claimed invention relates generally to the field of computer network systems. More particularly, embodiments of the present claimed invention relate to text based browser management of network systems.

### BACKGROUND ART

Information Technology organizations face difficult challenges in managing the availability of applications and computing resources within the enterprise. The growth of networks and distributed systems has led to an increasingly complex heterogeneous environment, encompassing a broad spectrum of hardware, software and operating systems. Today, systems range from PCs and technical workstations on user's desktops, to small and mid-size servers in departments, all the way up to large enterprise servers and mainframes in the corporate data-center. Computing resources may be geographically dispersed across a business campus or around the world to support global business operations. The proliferation of LANs and WANs means that users can access corporate information assets almost anywhere, any time of day or night.

In recent trends in distributed corporate computing, the use of mission-critical applications has blossomed, helping companies to become more competitive and conduct business more effectively. The mission-critical nature of these applications, however, is aggravating an already difficult system management task. Users are demanding systems and applications that are continuously accessible and available with expectations for improved levels of service that are constantly on the rise.

As the demands for acceptable service levels and the complexity of the computing environment have increased, administrators have responded by standardizing procedures and adopting network-aware tools. While limited in functionality, many of these tools have helped address the need for remote network management. Still other tools allow administrators to monitor individual systems and hardware components.

To meet the rising demands for better levels of service, it is crucial both to manage and monitor the availability of applications and data, as well as the availability of individual systems and networks, and administrators still lack an integrated way of doing so. While the job of managing systems, applications and data is becoming increasingly complex, IT managers must still control costs and provide non-interrupting services to their clients on a 24/7 basis. This calls for the system administrator to not only monitor and manage the availability of systems, but also to ensure that when a system goes down, the recovery time is kept to a minimum.

FIG. 1 is a prior art depiction of a network management system 100. The prior art system illustrated in FIG. 1 comprises three layer component of a console layer, a server layer 110 and a host layer 120A-120C.

The console layer comprises multiple consoles 101A-101B serving multiple users for the network management system 100. The consoles 101A-101B provide visual representations of managed objects (for example, hosts and networks) to users of the network management system 100. The consoles 101A-101B also provide users with the ability to manipulate attributes and properties associated with the managed objects and the ability to initiate management tasks (for example, dynamic reconfiguration of a host or a device).

The server layer 110 accepts requests from users through the consoles 101A-101B and passes these requests to the appropriate host. The server 110 then relays the response from the agent back to the user. For example, if a user wants information on the number of users accessing a host, the server 110 receives this request from any one of consoles 101A-101, and sends the request to that particular host. The host finds the requested information and passes it back to the server which then transmits the information to the user via the console 101A-101B. The server 110 also provides the consoles 101A-101B with a secure entry point to interface with the hosts 120A-120C.

The hosts 120A-120C perform the actual tasks of information gathering, monitoring and management of objects on the nodes managed by the network management system 100. The server 110 interacts with the hosts 120A-120C to gain access to managed objects on the network.

Although the prior art system illustrated in FIG. 1 provides the user with the convenience of accessing network resource services, the prior art system does not provide the user with the ability to monitor and measure network—service availability or unavailability.

### SUMMARY OF INVENTION

Accordingly, there is provided a multi-host, network system comprising a network server having a network monitoring and measurement system for monitoring and measuring the availability of system resource services in the network.

What is described herein is a computer network management system having a server with a software based system monitoring and measurement system for monitoring and measuring network service availability. Embodiments of the present invention allow users to measure and monitor the availability of network services by regularly contacting the services to determine the availability of the accessed service. The present invention allows users to monitor network resources to determine the status of the resources and when the resource are unavailable, the reason for the unavailability.

Embodiments of the present invention also include a monitoring unit that enables the user to determine the mean time between failure when a network service becomes unavailability and when the service becomes available. The user checks for a particular service's availability by regularly sending dummy transactions to the service per the user's request and gathers data to determine the availability status of the service being monitored. The data gathered as a result of such periodic transmittals of dummy transactions enables the present invention to calculate the time it takes a service to fail.

Embodiments of the present invention also include a monitoring unit that enables the user to determine the mean time to recover from a service failure when a service fails. The user checks for a particular service's availability by sending periodic monitoring transactions to the service. If the service does not respond to a monitoring transaction, the service is assumed to be unavailable. Data gathered from such a monitoring request is used to determine how quickly the service recovers from a failure.

Embodiments of the network service monitoring and measurement system of the present invention also include a services scalar table generator provides the user with the ability to define the service variables (factors) that the user wishes to monitor. The scalar table generator also provides entries for the name of the service being monitored, the port number of the connecting server, the percentage time for the service, the availability of the service, the mean time between failure of the service and the mean time between recovery of a failed service.

Embodiments of the network service monitoring and measurement system of the present invention further include a configuration data generation unit for storing configuration information data for each service being monitored and measured. The configuration file that the configuration unit generates is different and specific to each service request transaction the user generates to a particular service. The configuration file also includes any configuration parameters for each service request the user issues.

Embodiments of the network services monitoring and measurement system of the present invention further include a services vector table generation unit that provides specific configuration service information pertaining to the service being monitored and measure and the service environment (server). The information generated by the vector table generator includes the server name and port number where the service is running, the last time a request was sent to the service, the availability of the service when the last request was sent.

Embodiments of the network services monitoring and measurement system of the present invention include a protocol generation unit that provides the protocol information associated with each user service request to the service server. The protocol information allows user service requests to be transmitted to specified service servers with their native protocol packets.

These and other objects and advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of a prior art computer network system;

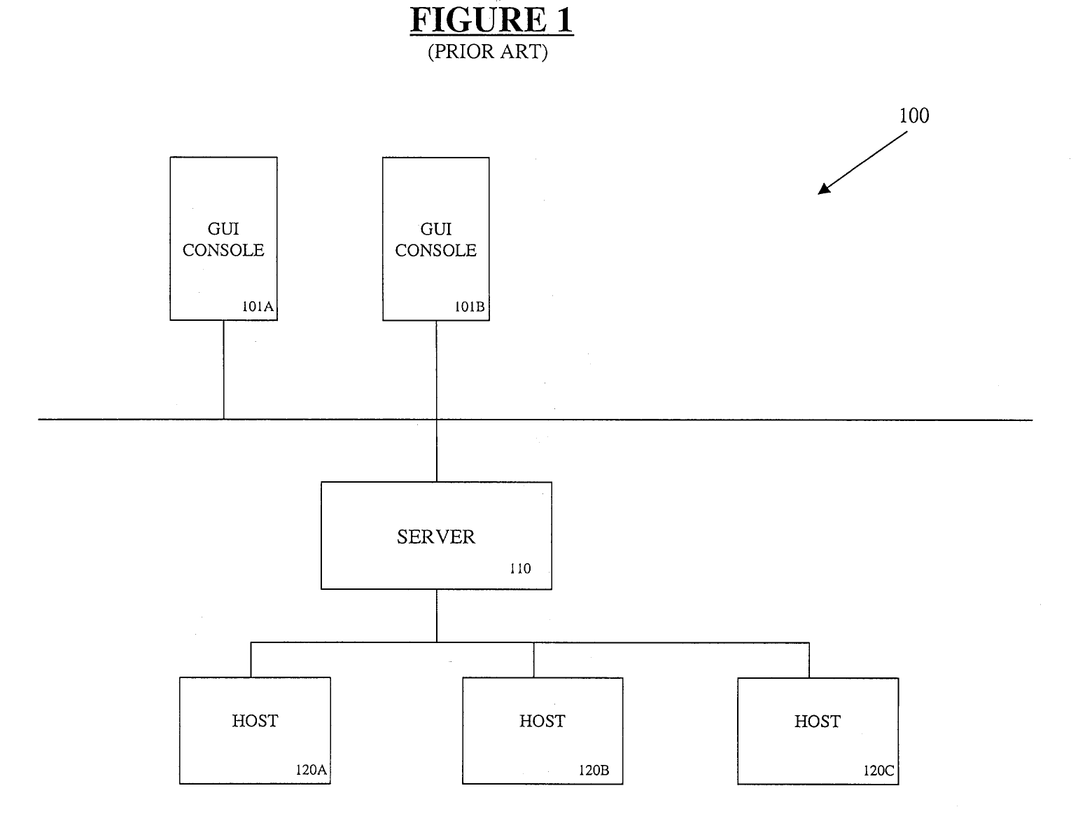

FIG. 2 is a block diagram of a computer network system in accordance with an embodiment of the present invention;

FIG. 3 is block diagram illustration of one embodiment of a system availability measurement and monitoring system of an embodiment of the present invention;

FIG. 4 is a block diagram illustration of an embodiment of the internal architecture of the system availability measurement and monitoring system of FIG. 3;

FIG. 5 is a block diagram illustration of one embodiment of a data acquisition system for a network service of an embodiment of the present invention;

FIG. 6 is a block diagram of an embodiment of a data acquisition system for a network service of another embodiment of the present invention; and

FIG. 7 is a flow diagram of one embodiment of the system availability measurement and monitoring system of the present invention.

### DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments.

On the contrary, the invention is intended to cover alternatives, modifications and equivalents, which may be included within the spirit and scope of the invention as defined by the appended Claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail as not to unnecessarily obscure aspects of the present invention.

The embodiments of the invention are directed to a system, an architecture, subsystem and method to process data in a computer network system. In accordance with an aspect of the invention, a system for measuring and monitoring the availability of network services in a network management system provides users the ability to conduct periodic monitoring and measurement of network service resources to determine the availability of these resources.

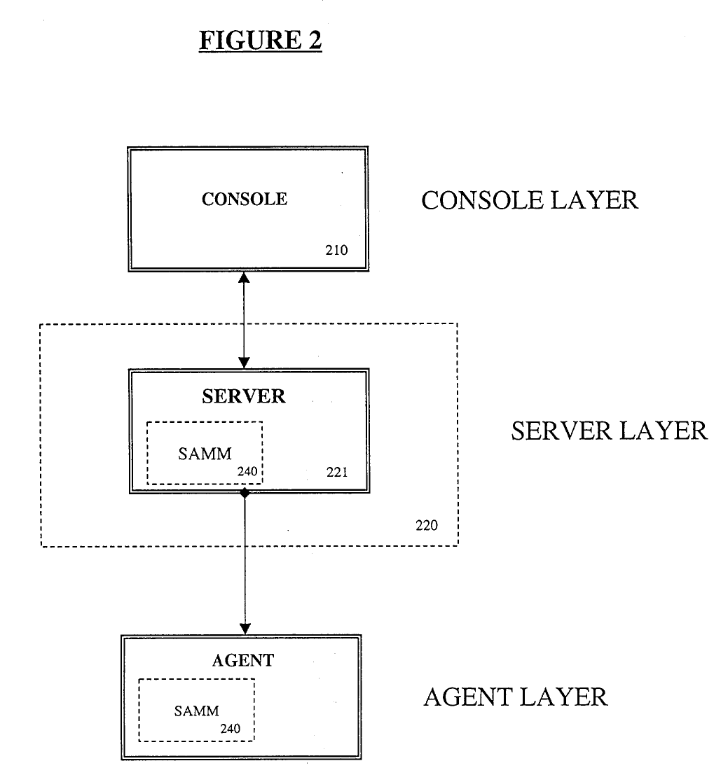

FIG. 2 is a block diagram depiction of one embodiment of a network management system 200. The network management system 200 illustrated in FIG. 2 comprises console layer 210, server layer 220 and agent layer 230. The agent layer comprises system availability measurement and monitoring system (SAMM) 240 of the present invention.

The console layer 210 comprises multiple consoles serving multiple users for the network management system 200. The consoles provide graphics visual representations of managed objects (for example, hosts and networks) to users of the network management system 200. The consoles also provide users with the ability to manipulate data attributes and properties associated with the managed objects and the ability to initiate management tasks (for example, dynamic reconfiguration of a host or a network) with graphics interface tools.

The server layer 220 comprises a server 221 that accepts requests from users through the consoles 210 and passes these requests to the appropriate agents in the agent layer 230. The server provides a secure centralized point of access for all system management operations. All requests from the console layer 210 are funneled through the server 221. The server 221 acts as a focal point that provides a number of core centralized service.

First it receives and routes requests from multiple user console. The server 221 recognizes duplicate requests intelligently consolidating them for a higher network and system efficiency. Secondly, the server 221 enforces the security models, authenticating users and handling all user session management. The server 221 receives all system status information to all interested console clients. The server 221 then relays the response from the agents 230 back to the user.

For example, if a user wants information on the number of users accessing services over the network, the server 221 receives this request from any one of consoles 210 in the console layer, and sends the request to that particular agent. The agent 230 finds the requested information and passes it back to the server 221 which then transmits the information to the user via the consoles. The server 221 provides the consoles with a secure entry point to interface with the agents.

The agent layer 230 monitors managed objects in the network. Two types of components exist at the agent layer—agents and probe daemons. Both run as background processes on managed objects. The agents 230 perform management tasks through use of management modules that are easily extensible and customizable. The agent layer 230 includes default modules that provided the infrastructure for the network services.

In one embodiment of the present invention, the agents 230 use rule-based technology to determine that status of the managed objects. The agents 230 store data and status of managed objects in a management information base (MIB). The MIB acts a repository for managed objects. The managed objects together represent a model of the system and its components being managed. The managed objects are arranged in a tree, showing a hierarchical relationship of the components. Within the MIB, managed objects are logically grouped into management modules that collectively implement management functions.

The agent layer 230 further comprises a system availability measurement and monitoring (SAMM) system 240 of the present invention that allows users to specify network services they wish to measure and monitor. The SAMM 240 can be dynamically loaded into the agent layer 230 by a user to perform the data gathering for the user to determine whether specified network services are available or unavailable. The SAMM 240 provides service modules that are loadable by the agent 230 to monitor a particular network service.

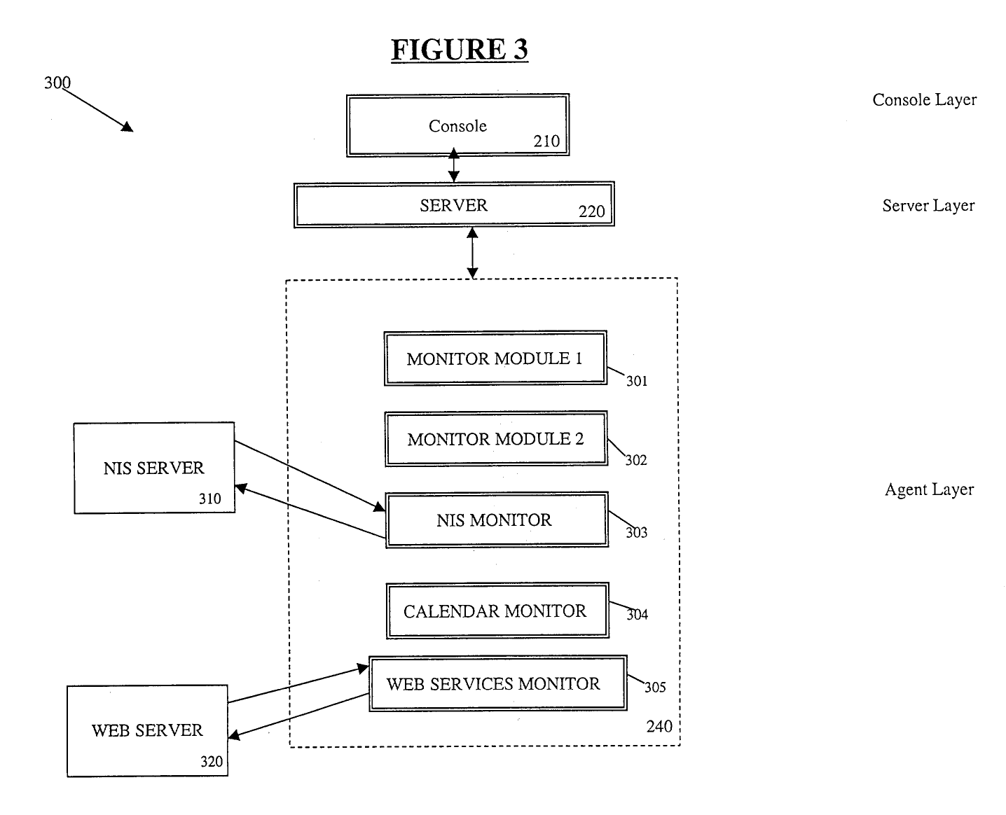

In one embodiment of the present invention, the SAMM 240 comprises a plurality of monitoring modules (see FIG. 3) with each module monitoring one service using one service specific protocol. Thus, there is a one-to-one correspondence between the number of service modules and the number of services being monitored. In one embodiment of the present invention, the monitor modules may be loaded locally at a service server site to perform local measurements and monitoring of a service locally on a server system. Similarly, a remote site module may be loaded on a remote user site to monitor a service remotely at a user site.

In one embodiment of the present invention, the remote site modules are referred to as synthetic transaction modules. The synthetic transaction modules have the ability to monitor and measure service availability from a user site. The synthetic transaction modules simulate user service requests to the service server by periodically sending service requests to a particular service per a user's setting to monitor a service and also checks the availability of a service server.

In one embodiment of the present invention, the user can access different services from the remote sites by issuing service requests based on user specific configurations. The configuration information is different for different services. For example, for DNS services, the request may have the names of the host servers to be resolved, domain names of the host server, etc. The configuration information may also be different for each server. For a service being monitored, the configuration data may be classified into two types:

1) A common configuration data: such data may be common across all service requests of a service. All services have the type of data. For example, the port where services are running, username, etc. All service requests are sent to the service running at that port using the same username, etc.

2) Specific configuration data: this data is different for each service request of a service. For example, for a specific FTP service being monitored, one request will be to do a get operation and another will be to do a port operation.

FIG. 3 is a block diagram of one embodiment of the system availability measurement and monitoring system (SAMM) 240 of the present invention. As shown in FIG. 3, the SAMM 240 comprises a plurality of user loadable monitor modules 301-305, and service element module 310-320. In one embodiment of the present invention, the modules 301-305 are user loadable and they send periodic requests to the various services, which may be running locally or remotely, that a user wishes to monitor and measure in the network 200 and gather data. In the present invention, the modules 301-305 are referred to as synthetic modules. Each of these synthetic transaction modules 301-305 has the ability to monitor and measure the availability of specific services from a user site. There is a separate module for each service that the user wishes to monitor. For example, the user may wish to monitor and measure the availability of a web service (e.g., module 305) or a calendar service (e.g., module 304).

Each of the service element modules 310-320 provides the network infrastructure that enables the user to measure the availability of the network services being monitored from the service site. There is a separate service element module 310-320 for each service being monitored. Typically, each of the service element module 310-320 determines the service availability of the service being monitored and retrieves information on the service using a service specific protocol (e.g., HTTP) on a service site.

The service element modules 310-320 also measure the response time to connect to a requested service locally. The service element modules 310-320 further provide process monitoring statistics for the underlying service protocol daemon along with file monitoring capabilities. In one embodiment of the present invention, the service element module may parse a file access log statistics such as total errors encountered during a service access, total files transferred, etc.

In the exemplary illustration of the SAMM 240 shown in FIG. 3, the NIS service element 310, for example, determines NIS service availability and the ability of the NIS daemon to resolve a name. In one embodiment of the present invention, the name resolution of the following types: username; hostname; Unix group name; and Mail alias, are handled by the NIS service element module 310. The module 310 also, in one embodiment, provide server response time locally to a user.

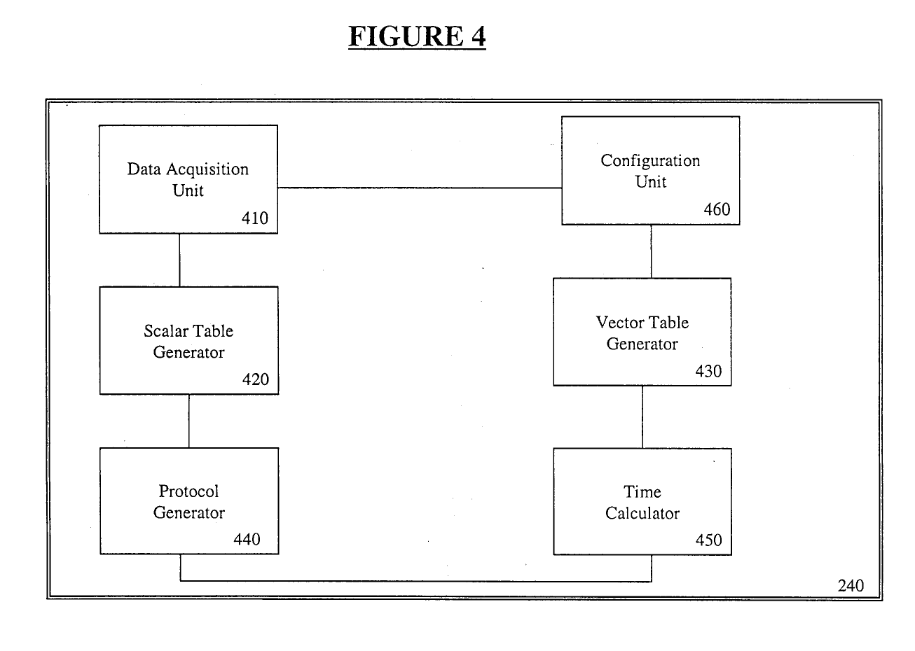

Referring now to FIG. 4 is a block diagram illustration of an internal architecture of one embodiment of the system availability measurement and monitoring system (SAMM) 240 of the present invention. As shown in FIG. 4, the SAMM 240 comprises data acquisition unit module 410, scalar table generator 420, vector table generator 430, protocol information generator 440, time calculator 450 and configuration unit 460.

The data acquisition unit 410 provides a mechanism for the SAMM 240 to gather data about the service being monitored and the service requested. The data gathered may include status information of the service, protocol information, and availability information of the service. The data acquisition unit 410 may also gather uptime information of a service server. The uptime information enables the SAMM 240 to calculate the mean time between failure and the mean time between recovery of a service being monitored. The data acquisition unit 410 further gathers data such as the connection time for a request transaction, the total time for the transaction, the network time for the transaction and the server time for the transaction.

The scalar table generator 420 provides the user with the ability to define the service variables (factors) that the user wishes to monitor. In one embodiment of the present invention, the scalar table generator comprises entries for the name of the service being monitored, the port number of the connecting server, the percentage time for the service, the availability of the service, the mean time between failure of the service and the mean time between recovery of a failed service. In one embodiment of the present invention, the user is able to populate a scalar table generated by the scalar table generator 420 by providing input information to the SAMM 240 that includes the name of a module instance, a description of a module instance, a host name and port number where a particular service is running, user passwords, etc.

The vector table generator 430 provides the SAMM 240 specific configuration service information pertaining to the service being monitored and measure and the service environment (server). The information generated by the vector table generator 430 includes the server name and port number where the service is running, the last time a request was sent to the service, the availability of the service when the last request was sent. If the service is not available, the vector generator 430 generates the likely cause for the non-availability of services either due to a network fault or a host down time. The vector generator also generates any other common configuration parameters such as the username, etc.

The protocol unit 440 provides the protocol information associated with each user service request to the service server. In one embodiment of the present invention, one synthetic modules monitors only one service using one protocol. In an exemplary service monitoring, the user provides the SAMM 240 with the port number where the service is running on a local system. If the user does not provide a port number, a default port number for the particular protocol is assumed to connect the user to the service server. When a user connects to a service server, the SAMM 240 send protocol specific packets to the server based on the service being requested. Exemplary protocols used by SAMM 240 include HTTP for web services requests, FTP for FTP service requests, SMTP for mail service requests, etc.

The configuration unit 460 stores configuration information data for each service being monitored and measured. In one embodiment of the present invention, the configuration file that the configuration unit 460 generates is different and specific to each service request transaction the user generates to a particular service server. The configuration file also includes any configuration parameters for each service request the user issues. These may include common configuration parameters such as the username, etc. In one embodiment of the present invention, the configuration files are editable by the user.

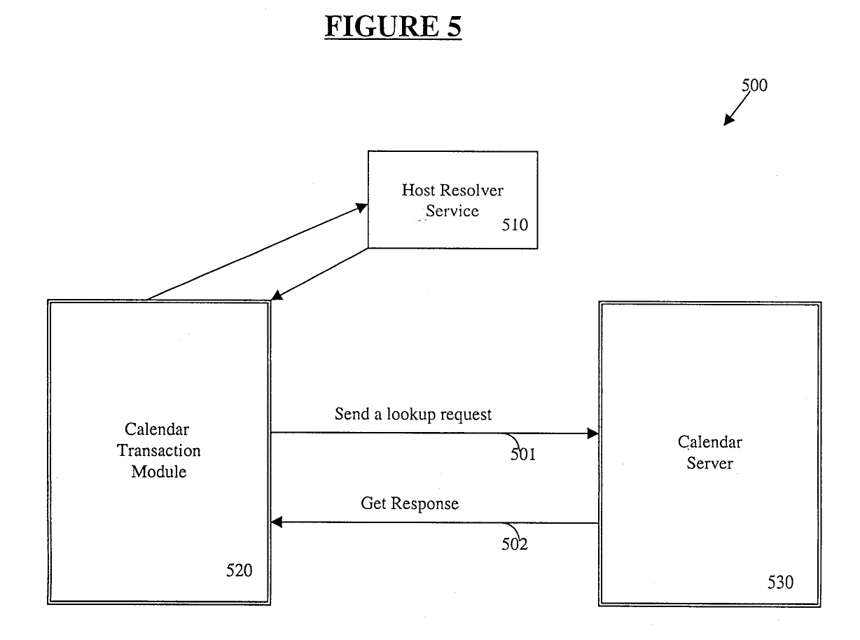

FIG. 5 is a block diagram illustration of one embodiment of an exemplary data acquisition module architecture of a calendar transaction module architecture 500 of one embodiment of the present invention. In the exemplary illustration shown in FIG. 5, if there is data in the calendar transaction table 520, the module 304 sends a user configured request at each refresh interval to the calendar service running remotely and retrieve mail.

In one embodiment of the present invention, each user calendar request comprises the following. First is resolving the server name 510 on which the calendar service is running. This gives the resolution time. Second is sending the request to the calendar server 530 to perform a lookup calendar.dtcm_lookup is used for this purpose. Third is setting the response, and this gives the calendar retrieval time. The sum taken for all the steps is the total transaction time. If the request is successful in retrieving the message, it populates the table with the various response times and indicate that the calendar service is available in the server details managed object. If the request is not successful, then an error is returned by the request and analyzed to find out the cause of failure. Based on the analysis, if it is determined that the server or service is unreachable, a refresh of the server details managed objects is performed to find out the likely cause of failure.

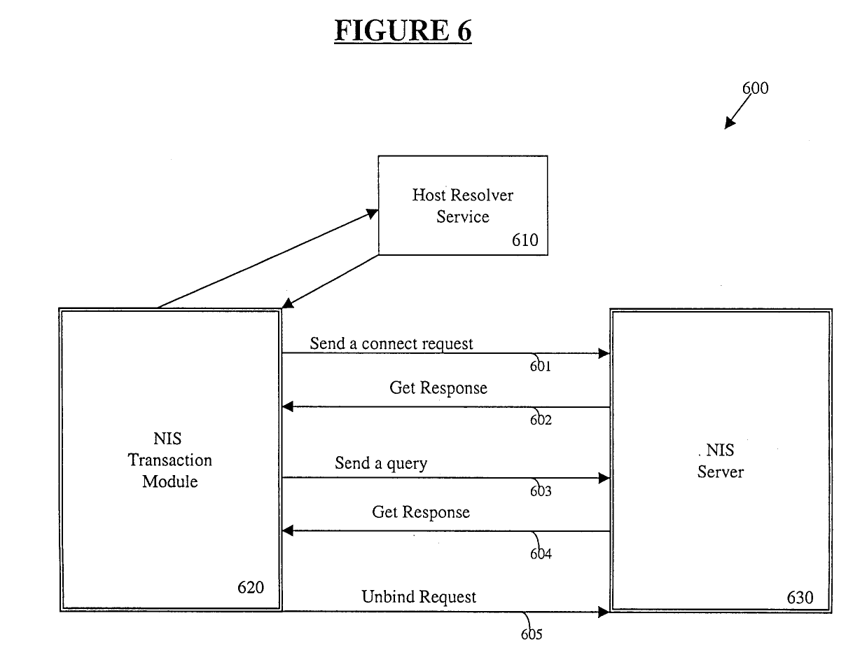

FIG. 6 is block diagram illustration of another exemplary transaction flow 600 of a synthetic translation module of the present invention. The illustration in FIG. 6 is an exemplary NIS transaction module 620 architecture. In the example shown in FIG. 6, if there is data in the NIS transaction table 620, the module sends a user configures request at each refresh interval to the NIS service running remotely to gather data. The module uses library routines provided as an interface to a NIS server 630 to send the requests and resolve the names. Each request consists of the following steps:

1) Resolve the server name on which the NIS service is running. This gives the server name resolution time;

2) Send a yp_bind request to the server and receive response. This gives the connect time;

3) Send a search request to the server. This gives the name resolution time; and

4) Send a yp_unbind request to free resources.

The sum of the time taken for all the steps above is the total transaction time. If a request is successful in resolving the hostname, it populates the table with the various response times and indicates that the NIS service is available in the server details managed object.

If the request is not successful, then the error returned by the request is analyzed to find out the cause of failure. Based on the analysis, it is determined that the server or service is unreachable, a refresh of the server details managed objects is performed to find out the likely cause of failure.

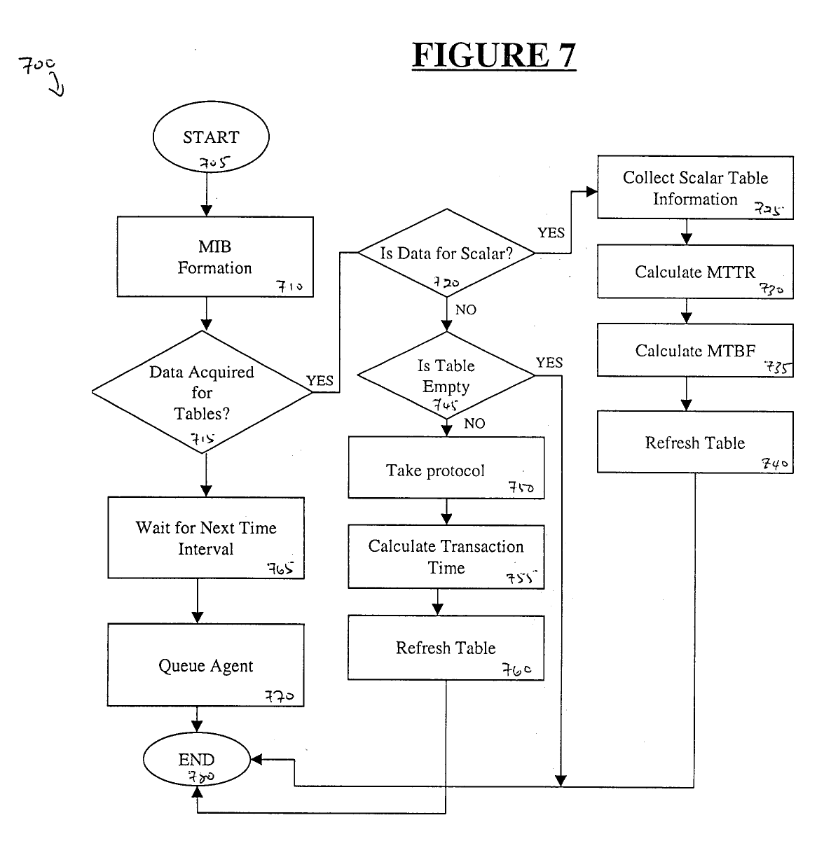

FIG. 7 is a computer implemented flow diagram illustration 700 of one embodiment of the network service availability monitoring and measurement system of the present invention. The network service availability monitoring and measurement of network services is initiated at step 705 upon initiation of the measurement system (SAMM 230) initiating a management information base that stores the status of the managed objects on the network to which the SAMM 230 is connected.

At step 715, the SAMM 230 determines whether the required data transaction tables for a particular user and a particular service request is initiated to begin a monitoring and measurement operation. In one embodiment of the present invention, the SAMM 230 utilizes vector and scalar transaction tables to accomplish the processing of service requests to the service servers to determine the availability or unavailability of requested services. If the SAMM 230 determines that the requisite data has been acquired for further processing of a service request, processing continues at step 720, else processing continues at step 765.

At step 720, the SAMM 230 determines whether data acquired for further processing a service request is designated as scalar data. In making this determination, the SAMM 230 decides whether the input data is scalar based on the data provided by the user. In one embodiment of the present invention, a scalar data may include user password, a host name, a service connection port number, etc.

At step 725, the SAMM 230, upon determining that a user input data is scalar, collects the data to generate a scalar table of the requested service information.

At step 730, the SAMM 230 utilizes the data gathered regarding a request service monitoring and measurement operation to calculate the mean time between recovery if the SAMM 230 encounters a service failure during an initial attempt to contact the service or during an access to the service. A recovery from an unavailable service enables the SAMM 230 to calculate the time between when the service was unavailable and when the service became available.

At step 735, the SAMM 230 gathers data from the contact service server in order to be able to calculate the meantime between failures for services being requested by the user.

At step 740, the SAMM 230 periodically refreshes the server details of managed objects utilized in processing a service request at small intervals. In one embodiment of the present invention, these small intervals may be in seconds when there is no data (rows) in a particular transaction table. In one embodiment of the present invention, as soon as there is data in a transaction table, the refresh interval is modified to be at larger intervals. This is because since the transaction table has data in it, the table is refreshed periodically to determine availability of a requested service.

At step 745, if the SAMM 230 determines that data acquired to generate the transaction tables is non-scalar, the SAMM 230 determines whether the transaction table is empty. If the transaction table is empty, the SAMM 230 ends the service request process at step 780.

At step 750, if the transaction table is empty the SAMM 230 takes the underlying protocol to the incoming service request to generate the requisite protocol specific packets required to connect to the service server and to send the appropriate service packets. The SAMM 230 further receives response back from the service server and monitors and measures the time it takes to complete a transaction.

At step 755, the SAMM 230 calculates the transaction time for the available service. In one embodiment of the present invention, the transaction time also enables the SAMM 230 to calculate the total time it takes for the SAMM 230 to process a particular service request to the service server.

At step 760, the SAM 230 performs a transaction table refresh similar to that performed at step 740. At step 765, if the SAMM 230 is unable to acquire any data during a poll to a particular user's transaction table, the SAMM 230 waits for the next refresh time interval to perform a subsequent pool of the transaction table. The SAM 230 continues to poll the user's transaction tables until the SAMM 230 detects the availability of data in the transaction table, in the case of scalar table, to begin a service monitoring and measurement operation.

At step 770, the SAMM 230 queues a requesting agent during an on-going service request servicing process. In one embodiment of the present invention, the queuing agent includes a timer that enables the query of the transactions tables and processing terminates at step 780.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications are suited to the particular use contemplated. It is intended that the scope of the invention be defined by the Claims appended hereto and their equivalents.

1. A computer network system, comprising:
a server comprising a plurality of server network services hierarchically arranged as a plurality of managed objects, said server maintaining hierarchical and topology information of said managed objects;
a plurality of computer network agents;
a plurality of network consoles;
a network system management system for managing said plurality of agents, said server, and said plurality of consoles; and
a service measurement and monitoring system for monitoring the availability of said plurality of network services and reporting the availability of said plurality of network services to a requesting service availability request.

2. The computer network system of claim 1, wherein said service measurement and monitoring system further measures the availability of said plurality of network services to a requesting service user.

3. The computer network system of claim 2, wherein said service measurement and monitoring system comprises an information configuration unit for storing configuration information defining configuration parameters about each service being monitored and measured.

4. The computer network system of claim 3, wherein said service measurement and monitoring system further comprises a scalar data generation unit for user definable service parameters defining services a user wishes to measure and monitor.

5. The computer network system of claim 4, wherein said service measurement and monitoring system further comprises a vector data generation unit for generating system defined parameters for said services being measured and monitored.

6. The computer system of claim 5, wherein said service measurement and monitoring system further comprises a data acquisition unit for providing said service measurement and monitoring system a mechanism to gather data regarding said services being monitored.

7. The computer network system of claim 6, wherein said service measurement and monitoring system further comprises a protocol generation unit for generating service specific protocol information defining a communication protocol that a particular requested service uses.

8. The computer network system of claim 7, wherein said service measurement and monitoring system further comprises a timer unit for monitoring a service request processing time in said server.

9. The computer network system of claim 8, wherein said service measurement and monitoring system further comprise transaction generation units for periodically sending service requests to a particular service per a user's service monitoring.

10. The computer network system of claim 1, wherein said service measurement and monitoring system comprises a plurality of service modules, each configured to handle a single network service in said network system.

11. The computer network system of claim 10, wherein said plurality of service modules are loaded locally in said server to perform local service measurements and monitoring.

12. The computer network system of claim 10, wherein said plurality of service modules are loaded on a remote user site to enable remote monitoring and measurement of network services.

13. The computer network system of claim 12, wherein remote service modules periodically send service requests to said service server to determine the availability of services to remote users.

14. The computer network system of claim 13, wherein said service measurement and monitoring system further comprise a plurality of service element modules for providing a network infrastructure to measure the availability of network services being monitored from a service site.

15. A computer network management system, comprising:
a server comprising a plurality of server network services hierarchically arranged as a plurality of managed objects, said server maintaining hierarchical and topology information of said managed objects;
a rule-based management information base for managing the status of said managed objects; and
a service measurement and monitoring system for monitoring the availability of said plurality of server network services and reporting the availability of said plurality of server network services to a requesting service availability request.

16. The computer network management system of claim 15, wherein said service measurement and monitoring system further measures the availability of said plurality of server network services to a requesting service user.

17. The computer network management system of claim 16, wherein said service measurement and monitoring system comprises an information configuration unit for storing configuration information defining configuration parameters about each service being monitored and measured.

18. The computer network management system of claim 17, wherein said information configuration unit comprises configuration data common to a particular service measured and monitored across a service server.

19. The computer network management system of claim 18, wherein said information configuration unit further comprises specific configuration information defined for each service in a user's service request to the service server.

20. The computer network management system of claim 19, wherein said service measurement and monitoring system further comprises a scalar data generation unit for user definable service parameters defining a service to measure and monitor.

21. The computer network management system of claim 20, wherein said service measurement and monitoring system further comprises a vector data generation unit for generating system defined parameters for said service being measured and monitored.

22. The computer network management system of claim 21, wherein said service measurement and monitoring system further comprises a data acquisition unit for providing said service measurement and monitoring system a mechanism to gather data about said service being monitored.

23. The computer network management system of claim 22, wherein said service measurement and monitoring system further comprises a protocol generation unit for generating service specific protocol information defining a communication protocol used by a particular requested service.

24. The computer network management system of claim 23, wherein said service measurement and monitoring system further comprises a timer unit for monitoring a service request processing time in the server.

25. The computer network management system of claim 24, wherein said service measurement and monitoring system further comprise transaction generation units for periodically sending service requests to a particular service per a user's service monitoring.

26. The computer network management system of claim 15, wherein said service measurement and monitoring system comprises a plurality of service modules, each configured to handle a single network service.

27. The computer network management system of claim 26, wherein said plurality of service modules are loaded locally in said network server to perform local service measurements and monitoring.

28. The computer network management system of claim 27, wherein said plurality of service modules are loaded on a remote user site to enable remote monitoring and measurement of network services.

29. The computer network management system of claim 28, wherein said plurality of service modules are loaded on a remote user site to enabling the remote monitoring and measurement of network services.

30. The computer network management system of claim 29, wherein said remote service modules periodically send service requests to said server to determine the availability of services to the remote user.

31. The computer network management system of claim 30, wherein said service measurement and monitoring system further comprise a plurality of service element modules for providing a network infrastructure to measure the availability of network services being monitored from a service site.

32. A method of monitoring and measuring system services availability in a computer network, said method comprising:
receiving a user service request;
generating a management information base;
determining whether a user definable service information has been generated;
determining whether a service server defined configuration information has been generated;
generating a service transaction from a remote user site to a service server; and
generating periodic service request packets to the service server to determine the availability of a requested service.

33. The method of claim 32, further comprising acquiring the requisite data from a user to enable the monitoring of a requested service.

34. The method of claim 33, further comprising generating the requisite communication protocol for a service request to a service being monitored and measured.
